(19) United States
(12) Patent Application Publication
(10) Pub. No.: US 2012/0261927 A1
(43) Pub. Date: Oct. 18, 2012

(54) POWER TRANSFER SYSTEM FOR A GENERATOR

(75) Inventor: Richard J. Gilpatrick, Whitewater, WI (US)

(73) Assignee: Briggs & Stratton Corporation

(21) Appl. No.: 13/089,169

(22) Filed: Apr. 18, 2011

(51) Int. Cl. F02D 29/06; H01F 38/14

(52) U.S. Cl. 290/40 B; 307/104

(57) ABSTRACT

A system for transferring power includes an internal combustion engine and a generator driven by the engine. The system further includes a primary conductor coupled to the generator and a secondary conductor. The secondary conductor is physically independent from the primary conductor and configured to receive energy from the primary conductor through induction.

### BACKGROUND

The present invention relates generally to the field of generators, such as portable generators or secondary generators. More specifically, the present invention relates to an inductive power transfer system from a generator through an exterior structure of a dwelling.

A secondary generator is typically in the form of a stationary unit located outside of a home, business, living quarters, or other dwelling that includes an internal combustion engine that drives a generator to provide electricity. A portable generator also typically includes an engine driving an electric generator, with both the engine and generator being mounted to a portable frame that may include wheels. Secondary and portable generators are designed for outdoor use because both are typically driven by engines that produce exhaust as a byproduct of combustion. During an emergency, such as a power outage, secondary or portable generators may be used to supply backup power to the dwelling.

To supply backup power to indoor electrical loads, such refrigerators, televisions, electric heaters, etc., a power cord, such as a cable or a bundle of wires, links the secondary or portable generator to the indoor electrical system or individual outlets. In the case of secondary generators, an aperture is typically formed in an exterior surface of the dwelling, and a conductor is extended through the aperture to deliver electricity into the dwelling. The aperture is then sealed and shielded to prevent the elements and pests from passing through the aperture to the interior of the dwelling. In the case of portable generators, a power cord is typically passed through an open window or door to deliver power to indoor loads.

### SUMMARY

One embodiment of the invention relates to a system for transferring power. The system includes an internal combustion engine and a generator driven by the engine. The system further includes a primary conductor coupled to the generator and a secondary conductor. The secondary conductor is physically independent from the primary conductor and configured to receive energy from the primary conductor through induction.

Another embodiment of the invention relates to a system for transferring power into or out of a dwelling. The system includes first and second assemblies, where each assembly includes a coil and a power cord. The power cord is coupled to the coil and configured to convey electricity. The first and second assemblies are configured to be fastened to opposing sides of a structure that is at least one of a window, a wall, a floor, a roof, and a door. The first and second assemblies are further configured to communicate energy through the structure without a conductor that is physically connected between the first and second assemblies.

Yet another embodiment of the invention relates to a system for transferring power. The system includes a generator designed for outdoor use and having an engine, a first coil coupled to the generator, a controller configured to distribute electricity to indoor loads, and a second coil coupled to the controller. The first and second coils are configured to communicate, between one another via induction, information carried on at least one of a current and a field.

Another embodiment of the invention relates to a power transfer system that includes a first assembly and a second assembly. The first assembly includes a primary coil, a first housing at least partially surrounding the primary coil, a first power cord coupled to the primary coil and extending from the first housing, a lock configured to control access to an interior of the first housing, and a first fastener configured to couple the first assembly to a window. The second assembly includes a secondary coil, a second housing at least partially surrounding the secondary coil, a second power cord coupled to the secondary coil and extending from the second housing, and a second fastener configured to couple the second assembly to the window. The first and second assemblies are configured to be fastened to opposing sides of the window to communicate energy through the window via induction. The power transfer system further includes a socket electrically coupled to the first or second power cord.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, in which:

FIG. 1 is a perspective view of a portable generator according to an exemplary embodiment of the invention.

FIG. 2 is a side view of the portable generator of FIG. 1 and a sectional view of a dwelling according to an exemplary embodiment of the invention.

FIG. 3 is a perspective view of conductors mounted to a window according to an exemplary embodiment of the invention.

FIG. 4 is a side view of the conductors and a sectional view of the window of FIG. 3.

FIG. 5 is a side view of a secondary generator and a sectional view of a dwelling according to an exemplary embodiment of the invention.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

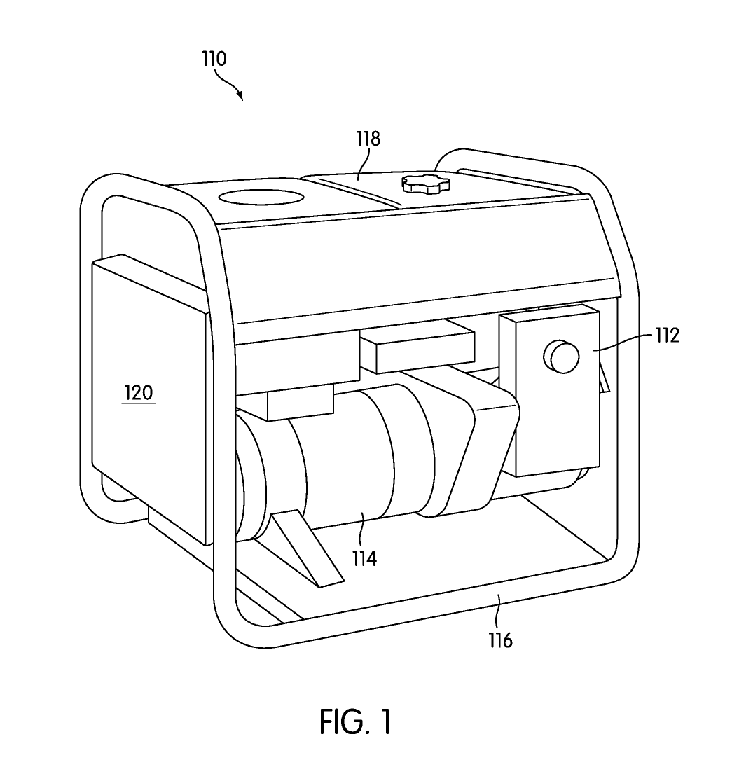

Referring to FIG. 1, a portable generator 110 includes a small, internal combustion engine 112 that drives a generator 114. The engine 112 and generator 114 are mounted to a frame 116, which also includes a fuel tank 118 and a first conductor 120. During operation, fuel is delivered to the engine 112 from the fuel tank 118, which drives the generator 114 to produce electricity. The electricity is then provided to the first conductor 120. In some embodiments, the first conductor 120 includes a coil configured to facilitate induction, a housing, shielding, or other features.

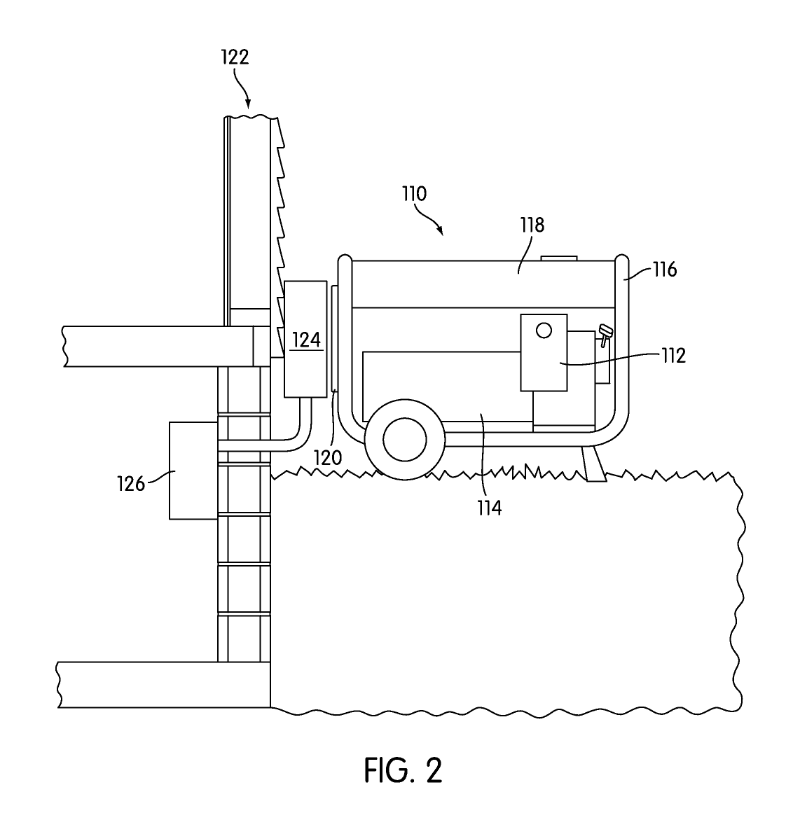

Referring to FIG. 2, the portable generator 110 is positioned in an outdoor location proximate to a dwelling 122. A second conductor 124 is coupled to the dwelling 122 and is configured to receive energy from the first conductor 120. According to an exemplary embodiment, the second conductor 124 is not physically connected to the first conductor 120, such as in a common housing, and both conductors 120, 124 are configured to be moved independently from one another. During operation of the portable generator 110, power is conducted from the generator 110 to the first conductor 120, from the first conductor 120 to the second conductor 124 via induction, and conducted from the second conductor 124 to electrical loads within the dwelling 122. According to an exemplary embodiment, the second conductor 124 is coupled to a controller 126 (e.g., breaker box, transfer switch, control module) that distributes the electricity provided by the portable generator 110 to various loads within the dwelling 122.

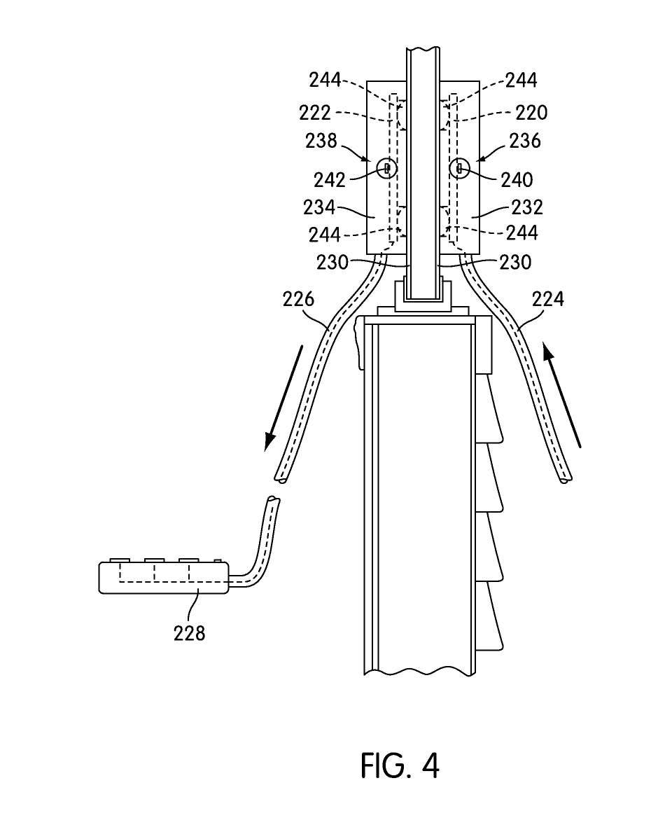

According to an exemplary embodiment, the first and second conductors 120, 124 each include coils (see, e.g., coils 220, 222 as shown in FIG. 4). The first conductor 120 includes the primary coil and the second conductor 124 includes the secondary coil, or vice versa. During operation of the portable generator 110, the first and second conductors 120, 124 are aligned so that electrical energy is transferred from one of the coils to the other via induction (e.g., direct induction, electromagnetic induction, magnetic induction power transfer, Tesla inductive coupling method). In some embodiments, the coils of the first and second conductors 120, 124 are resonant at about the same frequency and configured to facilitate resonant induction or electro-dynamic induction. Use of coils configured for resonant induction may improve the efficiency of the power transfer and allow for a greater distance between coils of the first and second conductors 120, 124.

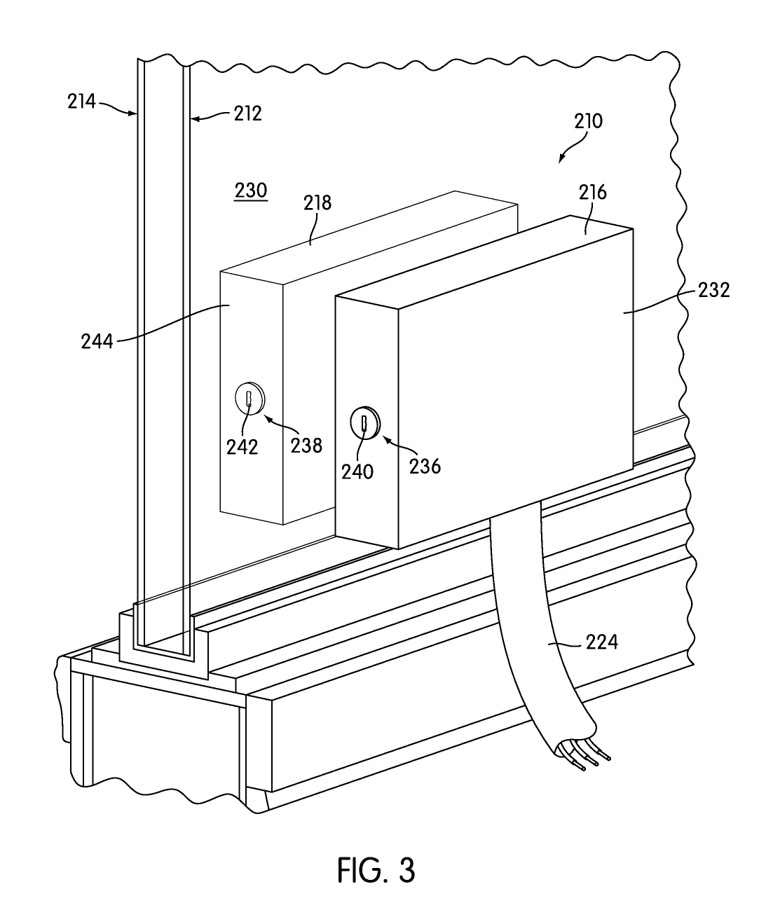

Referring now to FIGS. 3-4, a transfer system 210 for communicating energy between an exterior 212 and an interior 214 of a dwelling includes a first assembly 216 and a second assembly 218. Each assembly includes a coil 220, 222 (FIG. 4) and a power cord 224, 226 coupled to the respective coil 220, 222. The coil 220 of the first assembly 216 is configured to generate a magnetic field from electric current, and the magnetic field is received by the coil 222 of the second assembly 218 to generate electric current, and vice versa.

According to an exemplary embodiment, the first assembly 216 is coupled to a portable or secondary generator (see, e.g., portable generator 110 as shown in FIGS. 1-2), and the second assembly 218 is coupled to an indoor outlet 228. In other contemplated embodiments, the first and second assemblies 216, 218 may be used to communicate energy from an indoor source (e.g., outlet coupled to power grid) to an outdoor application, such as an electric leaf blower, lamps, or electric air compressor. In one such contemplated embodiment, the first and second assemblies 216, 218 may be used to provide power from an outlet in an attic to equipment on a roof of a dwelling, such as a motor configured to move a television antenna or satellite dish.

According to an exemplary embodiment, the first assembly 216 is configured to be placed on the exterior 212 of the dwelling and the second assembly 218 is configured to be placed in the interior 214 of the dwelling. The first and second assemblies 216, 218 are coupled to opposing sides of an exterior structure of the dwelling, such as a window 230 (e.g., double-pane window with air gap, single-pane window, window of door), a wall, a floor, a roof, a door (e.g., front door, garage door), or other structures, and are configured to communicate power by induction through the structure.

According to an exemplary embodiment, the first and second assemblies 216, 218 are configured to communicate power through the exterior structure of the dwelling without use of an aperture (e.g., cut hole, open window) in the structure. Exposure to the elements is prevented and entry points for pests are not created. In other contemplated embodiments, the first and second assemblies 216, 218 may be used to communicate power between interior structures of a dwelling, such as interior walls, floors, ceilings, doors, etc. Costs associated with forming permanent holes in the structures to run power cords through the structures are avoided. In still other contemplated embodiments, the first and second assemblies 216, 218 may be used to communicate energy between structures not associated with dwellings.

Referring to FIG. 4, the coils 220, 222 are sized and configured so as to be able to efficiently provide and receive energy from one another. In some embodiments, the coils 220, 222 are sized and configured to transfer energy through air with at least fifty percent efficiency over a distance of at least an inch, at least eight inches, or at least a foot. In some embodiments, the coils 220, 222 are sized and configured to transfer energy through air at such distances with at least seventy percent efficiency or at least ninety percent efficiency. In some embodiments, the coils 220, 222 are configured to transfer energy over such distances and with such efficiencies through other media, such as cement, glass, wood, brick, and other generally non-conductive building materials, or combinations of such media.

According to an exemplary embodiment, the first and second assemblies 216, 218 each include a housing 232, 234 (e.g., lock box, shell, case). Each housing 232, 234 may be designed to limit access to the respective coil 220, 222 and to impede removal of the corresponding first or second assembly 216, 218 from attachment to the structure (e.g., window, wall). In some embodiments, each housing 232, 234 is further configured to shield the respective coil 220, 222. The housings 232, 234 of the first and second assemblies 216, 218 may be substantially similar to one another in some embodiments, offsetting the moments on the structure provided by one another. In other contemplated embodiments one housing is particularly configured for outdoor use (e.g., sealed, water resistant, formed from a tough, heavy-duty plastic), while the other is particularly configured for indoor use (e.g., decorated, having a rounded and smooth surface, color coordinated). In still other contemplated embodiments only one of the assemblies 216, 218 may include a housing.

In some embodiments, the first and second assemblies 216, 218 each include a lock assembly 236, 238 configured to lock the respective housing 232, 234 in a closed configuration (e.g., locked configuration) where the respective coil 220, 222 is inaccessible through the housing 232, 234. Each lock assembly 236, 238 may include a key hole 240, 242 for activation or release of the respective lock assembly 236, 238. In some embodiments, release of each lock assembly 236, 238 allows access to the respective coil 220, 222 through a panel in the housing or by allowing removal of the housing from the structure (e.g., window, wall). In contemplated embodiments, a mechanical/electrical safety interlock may be incorporated with a lock assembly such that if the lock is unlatched, the electrical circuit to the coil is opened. In other contemplated embodiments, the lock assembly may be activated or released by a key pad, dial, or other system.

According to an exemplary embodiment, the first and second assemblies 216, 218 are configured to be attached to opposite sides of the window 230, such as opposite sides of one or more panes of glass in the window 230. In some such embodiments, suction cups 244 are used to hold the first and second assemblies 216, 218 to the window 230. In other contemplated embodiments, other fasteners are used to hold the first and second assemblies 216, 218 to the window 230, such as glue, magnets, or hooks or bars extending to a frame of the window 230.

In contemplated embodiments the first and second assemblies 216, 218 are configured to be attached to opposite sides of a cement wall with adhesive, such as the wall about a foundation or basement of a dwelling. In other contemplated embodiments, the first and second assemblies 216, 218 are configured to be attached to opposite sides of a wood and plaster wall or door with screws or nails, or to other structures or with other fasteners. In some embodiments, fasteners that hold the first and second assemblies 216, 218 to the structure (e.g., window, wall) are positioned within the respective housings 232, 234 and are inaccessible when the corresponding lock assembly 236, 238 is in the closed configuration.

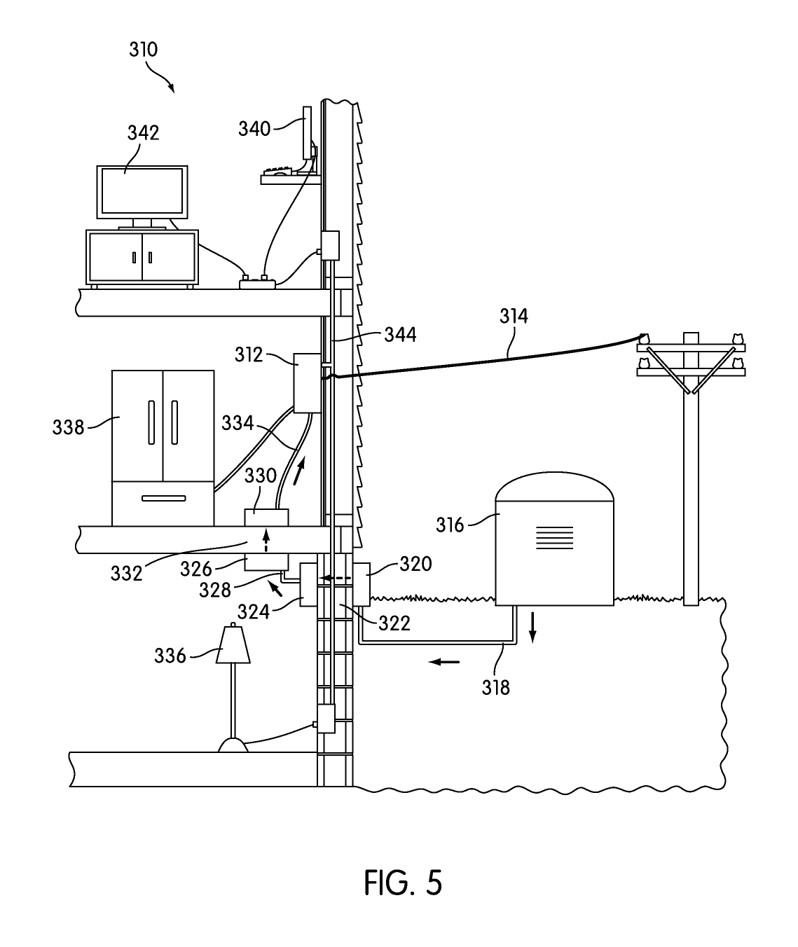

Referring to FIG. 5, a power transfer system 310 includes a controller 312 (e.g., smart box, computerized controller). A power grid 314 and a generator 316 (e.g., secondary generator, standby generator) are coupled to the controller 312. Power from the generator 316 may be supplied via a first power cord 318 to a first conductor 320, from the first conductor 320 through a wall 322 to a second conductor 324 via induction, from the second conductor 324 to a third conductor 326 via a second power cord 328, from the third conductor 326 to a fourth conductor 330 through a floor 332 via induction, and from the fourth conductor 330 to the controller 312 via a third power cord 334. The controller 312 may include or use a transfer switch to select which source, the power grid 314 or the generator 316, supplies the power to the dwelling.

Power supplied to the controller 312 is then distributed to various loads, such as a light 336, a refrigerator 338, an interface 340 in the form of a computer terminal, and a television 342. According to an exemplary embodiment, one or more of the loads are configured to communicate information (e.g., send or receive) with the controller 312 via electric power communication, where signals carrying the information are provided on the electrical network 344 of the dwelling. The signals are transmitted at a bandwidth (e.g., low bandwidth) that allows for the transmission between the coils without attenuation of the signals such that a substantial amount of the information is lost. The signals may be carried via current in the electrical network 344 or in fields passing between conductors, such as the first, second, third, and fourth conductors 320, 324, 326, 330, configured to communicate via induction. In some embodiments, the controller 312 may be or include components (e.g., control board, voltage regulator) of a Briggs & Stratton 50-Amp Automatic Transfer Switch (10 circuits), a Briggs & Stratton 100-Amp Outdoor Automatic Transfer Switch with load shedding, a Briggs & Stratton 200-Amp Automatic Transfer Switch with Service Disconnect, or a Briggs & Stratton 30-Amp Power Transfer System (10 circuits).

According to an exemplary embodiment, the controller 312 is configured to communicate with the generator 316 over conductors configured for induction, such as the first and second conductors 320, 324 located on opposite sides of the wall 322 or the second and third conductors 326, 330 located on opposite sides of the floor 332. In some contemplated applications, the controller 312 is configured to provide instructions for the generator 316 to change the electrical output of the generator 316. In other contemplated applications, the generator 316 is configured to provide status information to the controller 312, such as a fuel level, a present electrical output, a projection as to the amount of time remaining before the generator will run out of fuel, and maintenance needs of the generator 316.

In some embodiments, the power transfer system 310 further includes the interface 340, which may be particularly configured for indoor use by a human operator. The interface 340 is coupled to the controller 312 and is configured to relay information communicated from the generator 316 to the human operator. In some embodiments, the interface 340 is in the form of a computer or control panel with a digital display, which in some embodiments may not be physically coupled to the controller 312. In some embodiments, the interface 340 is able to communicate with the controller 312 via power-line communication. In other contemplated embodiments, the interface 340 may be integrated with a portable computer or smart phone, and in wireless communication with the controller 312.

According to an exemplary embodiment, the human operator is able to send commands to the generator 316 and the controller 312 via the interface 340. In some embodiments, the human operator is able to establish a prioritization scheme (e.g., logic, setting) for use of power provided by the generator 316. For example, in one such scheme the human operator may establish that power is to be distributed by the controller 312 only to the circuit to which the refrigerator 338 is coupled, and not to an outlet to which the television 342 is coupled. In another such scheme, the human operator may instruct the controller 312 to only distribute electricity to a lower priority load (e.g., the television 342) if the power demand of a higher priority load (e.g., the refrigerator 338) is fully met.

According to an exemplary embodiment, the interface 340 is configured to provide an audible alert, such as when the information communicated from the generator 316 indicates that the generator 316 is nearly out of fuel (e.g., less than a quarter of the fuel tank remaining). In some such embodiments, the audible alert is intended to notify the human operator to refill the fuel tank of the generator 316. Audible alerts may otherwise be used to indicate a failure or malfunction of the generator 316, an attempted theft of the generator 316, detection of motion near the generator 316, dislocation of one of the conductors 320, 324, 326, 330, or to indicate other events or conditions. In contemplated embodiments, alerts may be visual or tactile (e.g. vibrating cellular phone).

The construction and arrangements of the systems for transferring power, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, in contemplated embodiments other types of generators, such as wind-turbine generators, or other secondary power sources, such as portable battery banks, may transfer power through a window or other structure by induction using systems disclosed herein, and may be coupled to an outlet and/or an electrical system (e.g., smart box) of a dwelling to provide emergency power to loads interior to the dwelling, or may be coupled to an outlet of the dwelling to provide power from the outlet or other interior power source to electrical loads exterior to the dwelling. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A system for transferring power, comprising:
an internal combustion engine;
a generator driven by the engine;
a primary conductor coupled to the generator; and
a secondary conductor physically independent from the primary conductor and configured to receive energy from the primary conductor through induction.

2. The system of claim 1, wherein the primary conductor comprises a first coil and the secondary conductor comprises a second coil, and wherein the first and second coils are resonant at about the same frequency.

3. The system of claim 1, further comprising:
a first fastener configured to hold the primary conductor against a first side of a window; and
a second fastener configured to hold the secondary conductor against a second side of the window opposite to the first side such that the primary and secondary conductors are configured to transfer energy from the generator through glass of the window.

4. The system of claim 3, wherein the first and second fasteners comprise suction cups.

5. The system of claim 3, further comprising a housing configured to at least partially surround the primary conductor while the primary conductor is coupled to the window.

6. The system of claim 5, further comprising a lock assembly configured to lock the housing in a closed configuration to control access to the primary conductor.

7. The system of claim 6, wherein the primary conductor is coupled to the generator by a power cord.

8. The system of claim 7, wherein the secondary conductor is coupled to an outlet.

9. A system for transferring power into or out of a dwelling, comprising:
first and second assemblies, each comprising:
a coil; and
a power cord coupled to the coil and configured to convey electricity;
wherein the first and second assemblies are configured to be fastened to opposing sides of a structure, the structure being at least one of a window, a wall, a floor, a roof, and a door, and to communicate energy through the structure without a conductor that is physically connected between the first and second assemblies.

10. The system of claim 9, wherein the structure is the window, and the system further comprises suction cups configured to fasten the first and second assemblies to opposite sides of the window.

11. The system of claim 9, wherein the first assembly further comprises a housing configured to at least partially encase the coil of the first assembly while the coil of the first assembly is coupled to the structure.

12. The system of claim 11, further comprising a lock assembly configured to lock the housing in a closed configuration to control access to the coil of the first assembly.

13. The system of claim 9, wherein the structure is at least one of the wall, the floor, the roof, and the door, and wherein the first and second assemblies are fastened to opposite sides of the structure.

14. A system for transferring power, comprising:
a generator designed for outdoor use and comprising an engine;
a first coil coupled to the generator;
a controller configured to distribute electricity to indoor loads; and
a second coil coupled to the controller,
wherein the first and second coils are configured to communicate, between one another via induction, information carried on at least one of a current and a field.

15. The system of claim 14, wherein the first and second coils are configured to communicate information through an exterior structure of a dwelling, without use of an aperture in the structure.

16. The system of claim 14, wherein the generator is configured to communicate information associated with a status thereof to the controller via induction between the first and second coils.

17. The system of claim 16, wherein the generator is configured to receive information associated with a demand for electricity communicated via induction between the first and second coils.

18. The system of claim 14, further comprising an interface configured for indoor use by a human operator, and wherein the interface is coupled to the controller and configured to provide information communicated from the generator.

19. The system of claim 18, wherein the interface is configured to receive commands related to operation of the generator and to communicate the commands to the generator via the first and second coils.

20. The system of claim 19, wherein the interface is configured to provide an audible alert when the information from the generator indicates that the generator is nearly out of fuel.

21. A power transfer system, comprising:
a first assembly comprising a first coil, a first housing at least partially surrounding the first coil, a first power cord coupled to the first coil and extending from the first housing, a lock configured to control access to an interior of the first housing, and a first fastener configured to couple the first assembly to a window;
a second assembly comprising a second coil, a second housing at least partially surrounding the second coil, a second power cord coupled to the second coil and extending from the second housing, and a second fastener configured to couple the second assembly to the window; and
a socket electrically coupled to the first or second power cord;
wherein the first and second assemblies are configured to be fastened to opposing sides of the window, and to communicate energy through the window via induction.

22. The power transfer system of claim 21, wherein the first and second fasteners are suction cups.

23. The power transfer system of claim 22, wherein the suction cups are integrated with the respective first or second assembly so as to be positioned between the respective first or second housing and the window when the respective first or second assembly is coupled to the window.

24. The power transfer system of claim 23, wherein the housing limits access to the suction cups when the lock is engaged.

25. The power transfer system of claim 21, wherein the lock comprises a key hole configured to receive a key to engage and disengage the lock.

26. The power transfer system of claim 21, wherein the second assembly further comprises a second lock configured to control access to an interior of the second housing.

27. The power transfer system of claim 21, wherein the first and second housings are about the same size and shape.

28. The power transfer system of claim 27, wherein the first and second housings are rectilinear.
